(19) United States
(12) Patent Application Publication
(10) Pub. No.: US 2013/0025550 A1
(43) Pub. Date: Jan. 31, 2013

(54) LOWER COVERING OF A COOLING CHANNEL OF A PISTON

(71) Applicants: Wolfgang Ißler, Schwaikheim (DE); Linus Spatschek, Nagold (DE)

(72) Inventors: Wolfgang Ißler, Schwaikheim (DE); Linus Spatschek, Nagold (DE)

(21) Appl. No.: 13/478,935

(22) Filed: May 23, 2012

(30) Foreign Application Priority Data
May 24, 2011 (DE) 102011076369.4

(51) Int. Cl. F01P 3/10; F02F 3/22

(52) U.S. Cl. 123/41.35; 92/186

(57) ABSTRACT

A piston cooling channel cover is disclosed. The cover includes an annular lower cover, wherein the annular lower cover is at least one of a one part cover and a multi-part cover; at least one of a standpipe-like inflow and a standpipe-like outflow, wherein at least one of the inflow and the outflow are unitarily formed with the lower annular cover.

### CROSS-REFERENCES TO RELATED APPLICATION

This application is a National Stage application which claims the benefit of German Patent Application No. DE 10 2011 076 369.4, filed May 24, 2011, which is hereby incorporated by reference in its entirety.

### TECHNICAL FIELD

The present invention relates to a lower covering of a cooling channel of a piston of a combustion engine with at least one inflow and/or at least one outflow according to the preamble of claim 1. The invention additionally relates to a piston having a cooling channel covered by such a cover.

### BACKGROUND

To improve a catching and filling degree of a cooling channel on an oil-cooled piston, a standpipe is employed on an inflow or an outflow of the cooling channel. On steel pistons, e.g. monotherm pistons, on which the cooling chamber is closed off through inserted holding plates, such a use however cannot be realised easily. Alternatively, separate insert parts held through positive connection can also be used, but which leads to a greater complexity during the assembly and bears the risk that such insert parts come loose during engine operation.

From DE 199 60 913 A1 a generic covering of a cooling channel of a piston of a combustion engine is known, wherein in the covering a pipe-like inflow or a standpipe can be fastened in a simple manner. To this end, the standpipe or the pipe-like inflow is clipped into the lower covering or fastened through an engagement connection.

From DE 102 47 218 A1 a further covering of a cooling channel of a piston of a combustion engine is known, wherein in the region of the inflow and of the outflow of the cooling channel, a separate standpipe is installed, which because of its height prevents that a predefined quantity of oil exits the cooling channel. Here, the installation of the separate standpipe between a first and a second baffle plate is to improve the reliability of the piston and facilitate its manufacture at the same time.

Disadvantageous with the coverings or pistons known from the prior art, however, is that with these the standpipe required for ensuring a certain oil filling quantity in the cooling channel is produced separately and mounted subsequently, as a result of which the parts variety as well as the assembly costs increase.

### SUMMARY

The present invention therefore deals with the problem of stating an improved or at least an alternative embodiment for a lower covering or a piston of the generic type, which is characterized, in particular, by a simple and cost-effective production.

According to the invention, this problem is solved through the subjects of the independent claims. Advantageous embodiments are the subject of the dependent claims.

The present invention is based on the general idea of integrating in particular a standpipe-like inflow and/or in particular a standpipe-like outflow of a cooling channel of a piston of a combustion engine in a lower covering of the cooling channel, i.e. to produce such unitarily with the latter. The lower covering of the cooling channel in this case is designed (part)-annularly and comprises the inflow and the outflow likewise mentioned above, as a result of which rapid flowing-out of the oil can be avoided and thus improved cooling of the piston can be guaranteed. In contrast with the prior art, wherein the inflow and the outflow is always formed through separate standpipes each, the inflow and/or the outflow are now unitarily formed with the lower covering, in particular bent out of the latter or bent off by means of a forming operation, as a result of which both the parts variety as well as the assembly costs can be clearly reduced, since the inflow and outflow according to the invention now forms an integral part of the lower covering and a need no longer be assembled subsequently. Producing the inflow and outflow—as mentioned at the outset—can take place through a simple punching/forming process, wherein for example the lower covering is punched out of a metal sheet and the inflow and the outflow are subsequently or simultaneously formed partly through bending-over a metal sheet section. According to the invention, the inflow and outflow is thus formed through metal sheet sections of the lower covering bent into the cooling channel, as a result of which the oil quantity held in the cooling channel during the operation of the combustion chamber can be significantly increased and the cooling effect substantially improved.

With an advantageous further development of the solution according to the invention, the covering comprises at least two part annular, in particular semi-annular sections, on the face ends orientated in circumferential direction a half each of the inflow or outflow is bent outward, so that upon a joining of the individual sections, two adjacent sections each on the face end form and delimit and inflow or an outflow between them. In particular, with two semi-annular sections of the lower covering, the face ends of the coverings are accordingly shaped corresponding to the contour of the cooling channel and formed so that in the assembled state the oil in the cooling channel is obstructed from flowing back through the metal sheet sections bent inside. The at least two sections of the lower covering in this case can be designed as identical parts and because of this in turn can be produced cost-effectively, in particular with low unit costs.

With an advantageous further development of the solution according to the invention, the individual sections of the covering abut one another in the region of the respective inner radius or in the region of the respective outer radius at the face end, wherein the inflow or the outflow is located radially between these regions. In other words, this means that a diameter of the inflow and of the outflow is smaller, but maximally, however identical in size as the radial extension of the cooling channel. Through the corresponding selection of the forming tool, the diameter of the inflow and of the outflow can thus be individually influenced, so that it can be adapted to individual circumstances and in particular to individual cooling requirements. Because of this, a particularly high flexibility can be achieved.

Practically, the forming of the inflow and/or of the outflow takes place prior to the insertion of the covering or of the sections of the covering into the piston or after that. This means that the inflow and the outflow is optionally formed together with the production of the sections of the covering, wherein it is also conceivable that the sections of the covering or the covering as a whole are initially inserted in the piston and the standpipe-like inflow and/or the standpipe-like outflow is only formed, in particular bent over, in a following production step.

Further important features and advantages of the invention are obtained from the subclaims, from the drawings and from the associated Figure description by means of the drawings.

It is to be understood that the features mentioned above and still to be explained in the following cannot only be used in the respective combination stated, but also in other combinations or by themselves, without leaving the scope of the present invention.

Preferred exemplary embodiments of the invention are shown in the drawings and are explained in more detail in the following description, wherein same reference characters refer to same or similar of functionally same components.

### BRIEF DESCRIPTION OF THE DRAWINGS

Here it shows, in each case schematically:

FIG. 1 a first possible embodiment of a lower covering of a cooling channel of a piston according to the invention,

FIG. 2 a representation as in FIG. 1, however with a covering having two sections,

FIG. 3 a lower covering installed in a piston according to a first embodiment,

FIG. 4 a representation as in FIG. 3, however with a second embodiment,

FIG. 5 two face ends of individual sections of the covering, which upon joining form a common inflow or outflow,

FIG. 6 a further possible embodiment of a lower covering of a cooling channel of a piston according to the invention,

FIG. 7 a face end of a section of the covering with a bent-over metal sheet section,

FIG. 8 possible angular positions of the bent-up metal sheet sections to a piston axis.

### DETAILED DESCRIPTION

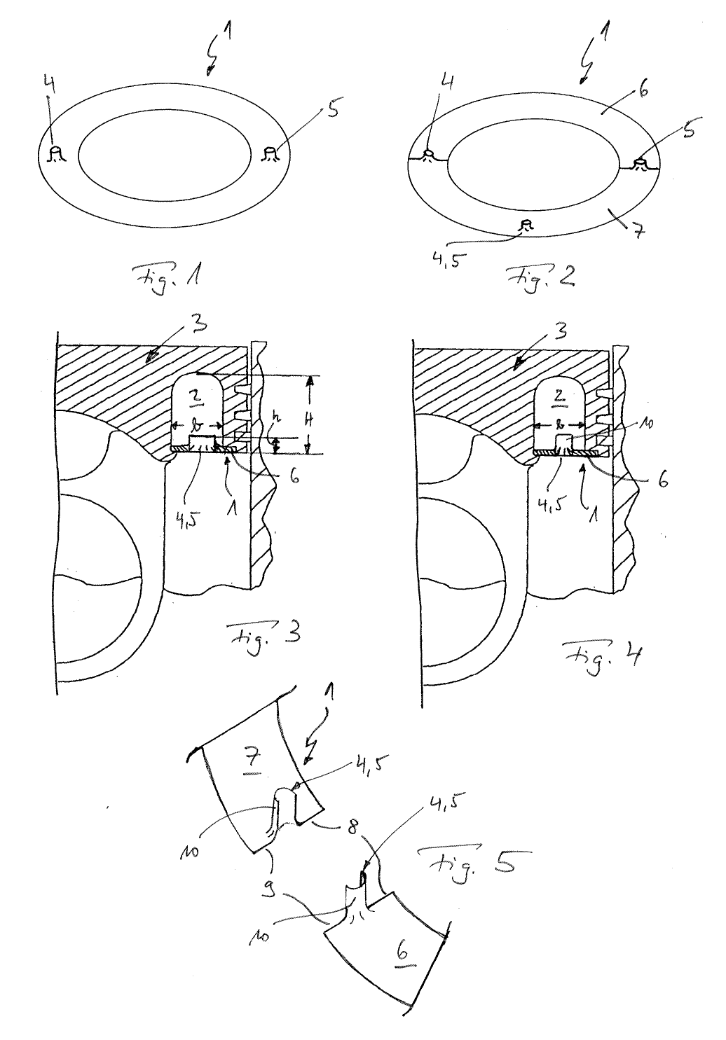

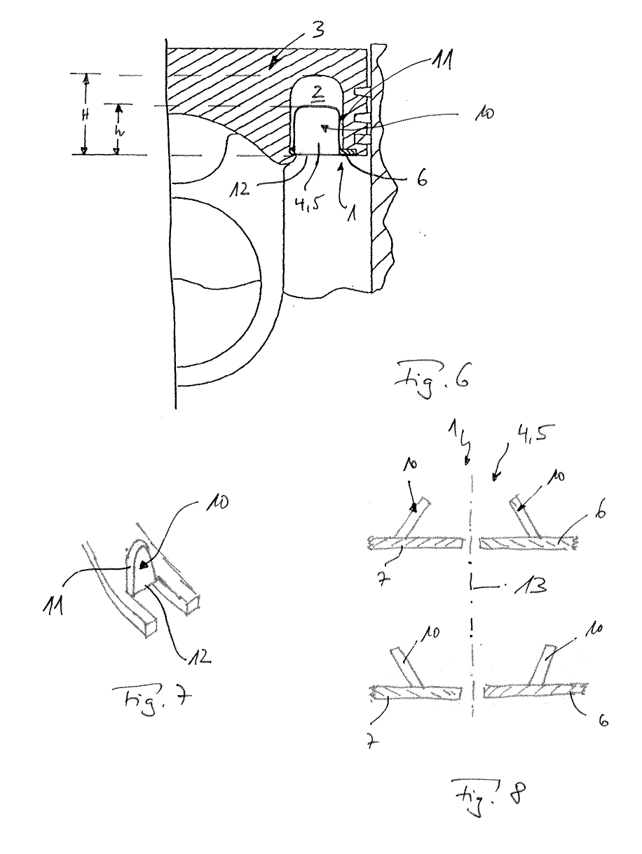

According to FIG. 1, a lower covering 1 of a cooling channel 2 (see also FIGS. 3, 4 and 6) of a piston 3 according to the invention has an annular shape, and in particular a standpipe-like inflow 4 and in particular a standpipe-like outflow 5. The inflow 4 and the outflow 5 in this case are formed unitarily with the lower covering 1, in particular bent out or formed from the covering 1, or at least partially formed by a bent-up metal sheet section 10. According to FIG. 1, the entire lower covering 1 is formed unitarily, whereas the covering 1 according to FIG. 2 consists of two semi-annular sections 6, 7, on the face ends of which a half of the inflow 4 and of the outflow 5 is bent out, so that upon a joining of the two sections 6, 7 two adjacent sections 6, 7 each form an inflow 4 and an outflow 5 at the face end between them (see also FIG. 5 in this regard).

Here, the covering 1 is preferentially embodied as punched shaped sheet metal part, wherein the inflow 4 and/or the outflow 5 is/are bent out of the covering 1. The bending out or the forming of the metal sheet section 10 forming the inflow 4 and/or the outflow 5 in this case can be carried out prior to the insertion of the covering 1 in the piston 3 or thereafter.

According to FIG. 2, a covering 1 is shown which is put together of two semi-annular sections 6, 7, wherein it is obviously also conceivable that the covering 1 has more than two sections 6, 7. In addition to this it is likewise conceivable that at least one section 6, 7 of the covering 1 not only comprises half of the inflow 4 or of the outflow 5 at the face end each, but during the further course another inflow 4 or an outflow 5.

For example, the covering 1 can also be joined from three individual sections.

Looking at FIGS. 3 and 4 it is evident that a diameter of the inflow 4 or of the outflow 5 merely comprises a part of the radial extension of the covering 1, wherein the diameter of the inflow 4 or of the outflow 5 is maximally limited to a radial width b of the cooling channel 2. The individual sections 6, 7 of the covering 1 can abut in the region 8 of the respective inner radius and/or in the region 9 of the respective outer radius at the face end, wherein the inflow 4 or the outflow 5 is radially located between these regions 8, 9. This is clearly evident in particular from FIG. 5, so that in this case the diameter of the inflow 4 or of the outflow 5 only is a part of the width b of the cooling channel 2.

Depending on the selected height h of the inflow 4 and/or of the outflow 5, an oil quantity held in the cooling channel 2 can be influenced and the cooling effect specifically controlled because of this. The height h is preferably in the range between 10 and 80%, in particular between 30 and 60% of the height H of the cooling channel 2. The bent-up metal sheet section 10 accordingly covers a region of 20-80% of the cross section of the cooling channel 2. The contour of the metal sheet section 10 can be matched to the contour of the cooling channel cross section, refer also FIG. 6.

FIG. 6 shows a further possible embodiment of the covering 1 according to the invention, wherein the inflow 4 and the outflow 5 is formed through simple, bent-up metal sheet sections 10, which with their edges 11 bear against an inner wall of the cooling channel 2 or are arranged near the latter, refer also FIGS. 7 and 8. The metal sheet section 10 thus forms a separating wall within the cooling channel 2. Compared with the inflows and outflows 4, 5 according to FIG. 5, producing the straight bent-up metal sheet section 10 according to FIG. 7 is particularly simple from a technical point of view. To facilitate the forming, a bending edge 12 of the metal sheet sections 10 to be bent up can be pre-stamped. As is evident from FIG. 8, the bent-up metal sheet section 10 can stand parallel or obliquely to the piston axis 13.

With the covering 1 according to the invention it is possible to produce the inflow 4 and/or the outflow 5 simply and cost-effectively from a production point of view, since it is no longer formed as usual in the past through separate standpipes. Through the omission of the previously required separate standpipes, the assembly effort can also be clearly reduced. Producing the inflow 4 and outflow 5 moulded onto the covering 1 according to the invention can be carried out in a punching and forming process that is easily mastered.

1. A piston cooling channel cover, comprising: an annular lower cover, wherein the annular lower cover is at least one of a one part cover and a multi-part cover; at least one of a standpipe-like inflow and a standpipe-like outflow, wherein at least one of the inflow and the outflow are unitarily formed with the lower annular cover.

2. The piston cooling channel cover according to claim 1, wherein the lower annular cover is a punched shaped sheet metal part, wherein at least one of the inflow and the outflow is at least partially a bent-up metal sheet section.

3. The piston cooling channel cover according to claim 1, wherein the lower annular cover comprises at least two sections, on the face ends of which a half each of an inflow or outflow is bent out, so that upon a joining of the individual sections two adjacent sections each form an inflow or an outflow at the face end between them.

4. The piston cooling channel cover according to claim 1, wherein a diameter of at least one of the standpipe-like inflow and the standpipe-like outflow amounts to at least a part of the radial extension of the lower annular cover or a part of a radial width (b) of the cooling channel.

5. The piston cooling channel cover according to claim 3, wherein the individual sections of the lower annular cover abut in the region of the respective inner radius and/or in the region of the respective outer radius, wherein the inflow or the outflow are located radially between these regions.

6. The piston cooling channel cover according to claim 1, wherein the forming of the inflow and/or of the outflow takes place prior to the insertion of the lower annular cover in the piston or after an assembly of the latter in the piston.

7. The piston cooling channel cover according to claim 2, wherein the bent-up metal sheet section stands at least one of parallel or obliquely to the piston axis.

8. The piston cooling channel cover according to claim 2,
wherein the bent-up metal sheet section has a first height (h) between and 80% of a second height (H) of the cooling channel, and
wherein the bent-up metal sheet section covers a part of 20-80% of the cross section of the cooling channel.

9. The piston cooling channel cover according to claim 2, wherein a bending edge of the metal sheet sections is a re-stamped edge.

10. A piston, comprising: an internally located, annular cooling channel, the cooling channel configured for cooling the piston during the operation of a combustion engine, wherein an annular lower covering of the cooling channel includes at least one of a standpipe-like inflow and a standpipe-like outflow, wherein at least one of the inflow and the outflow are unitarily formed with the lower covering.

11. The piston according to claim 10, wherein the covering is a punched shaped sheet metal part, and wherein at least one of the inflow and the outflow is at least partially bent-up metal sheet section.

12. The piston according to claim 10, wherein the piston a steel piston.

13. The piston according to claim 12, wherein the steel piston is a monotherm piston.

14. The piston cooling channel cover according to claim 2, wherein the lower annular cover comprises at least two sections, on the face ends of which a half each of an inflow or outflow is bent out, so that upon a joining of the individual sections two adjacent sections each form an inflow or an outflow at the face end between them.

16. The piston cooling channel cover according to claim 3, wherein a diameter of at least one of the standpipe-like inflow and the standpipe-like outflow amounts to at least a part of the radial extension of the lower annular cover or a part of a radial width (b) of the cooling channel.

17. The piston cooling channel cover according to claim 4, wherein the individual sections of the lower annular cover abut in the region of the respective inner radius and/or in the region of the respective outer radius, wherein the inflow or the outflow are located radially between these regions.

18. The piston cooling channel cover according to claim 5, wherein forming of the inflow and of the outflow takes place prior to the insertion of the lower annular cover in the piston or after an assembly of the latter in the piston.

19. The piston cooling channel cover according to claim 2, wherein the bent-up metal sheet section stands at least one of parallel or obliquely to the piston axis.

20. The piston cooling channel cover according to claim 2,
wherein the bent-up metal sheet section has a first height (h) between 10 and 80% of a second height (H) of the cooling channel, and
wherein the bent-up metal sheet section covers a part of 20-80% of the cross section of the cooling channel.
